(19) United States
(12) Patent Application Publication
(10) Pub. No.: US 2013/0232067 A1
(43) Pub. Date: Sep. 5, 2013

(54) Charge Allocation and Distribution

(71) Applicants: Amit Bhosle, Bellevue, WA (US); Ammar Chinoy, Seattle, WA (US); Michael Donikian, Seattle, WA (US); Ashish Agrawal, Seattle, WA (US)

(72) Inventors: Amit Bhosle, Bellevue, WA (US); Ammar Chinoy, Seattle, WA (US); Michael Donikian, Seattle, WA (US); Ashish Agrawal, Seattle, WA (US)

(73) Assignee: AMAZON TECHNOLOGIES, INC., Reno, NV (US)

(21) Appl. No.: 13/411,113

(22) Filed: Mar. 2, 2012

(51) Int. Cl. G06Q 40/00

(52) U.S. Cl. 705/44; 705/39

(57) ABSTRACT

Disclosed are various embodiments for facilitating the creation of allocation rules for distributing charges to one or more accounts associated with a payment instrument. The charge distribution application accesses allocation rules that are used to determine a charge distribution allocation for linked accounts associated with a master account identified in a charge request. The charge distribution application specifies a percentage of the amount indicated in the charge request to charge to one or more of the linked accounts. The charge distribution application charges up to the total amount specified in the charge request to one or more of the accounts depending on the applicable charge distribution allocation.

### BACKGROUND

Many consumers have both personal and business credit cards. Business credit cards or corporate credit cards allow tracking of company expenses and often provide the buying power needed to operate a business. A given business might employ many different cards for its employees establishing many different accounts. Managing multiple credit cards involves monitoring when each of the credit card payments are due, tracking reward points for each of the credit cards, evaluating varying interest rates for each of the credit cards, tracking expiration dates for each of the credit cards, and/or other credit card management activities.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of networked environment according to various embodiments of the present disclosure.

FIG. 2 is a drawing of an example of a user interface rendered by a client in the networked environment of FIG. 1 according to various embodiments of the present disclosure.

FIG. 3 is a flowchart illustrating one example of functionality implemented as portions of the cost sharing application executed in a computing device in the networked environment of FIG. 1 according to various embodiments of the present disclosure.

FIG. 4 is a schematic block diagram that provides one example illustration of a computing environment employed in the networked environment of FIG. 1 according to various embodiments of the present disclosure.

### DETAILED DESCRIPTION

The present disclosure relates to distributing charges to one or more accounts based on user-created business rules for transactions that occur on a master account. Various embodiments of the present disclosure facilitate creation of business rules for distributing charges to one or more accounts associated with a payment instrument. For example, the payment instrument may comprise a credit card, a debit card, a gift card, and/or other card. As an example, a user of a payment instrument initiates a transaction at a point-of-sale system. The payment instrument is swiped, scanned or otherwise entered at the point-of-sale system that generates a charge request and sends the charge request to the cost sharing application. A charge request may include, for example, a purchase, a cash advance, and/or other type of transaction by a user of the payment instrument.

Upon receipt of the charge request, the cost sharing application identifies a master account associated with the charge request. The cost sharing application accesses the business rules that are used to determine a charge distribution allocation for the master account. The charge distribution allocation specifies a percentage of the amount indicated in the charge request to charge one or more of the accounts. The cost sharing application charges up to the total amount specified in the charge request to one or more of the accounts depending on the applicable charge distribution allocation. In the following discussion, a general description of the system and its components is provided, followed by a discussion of the operation of the same.

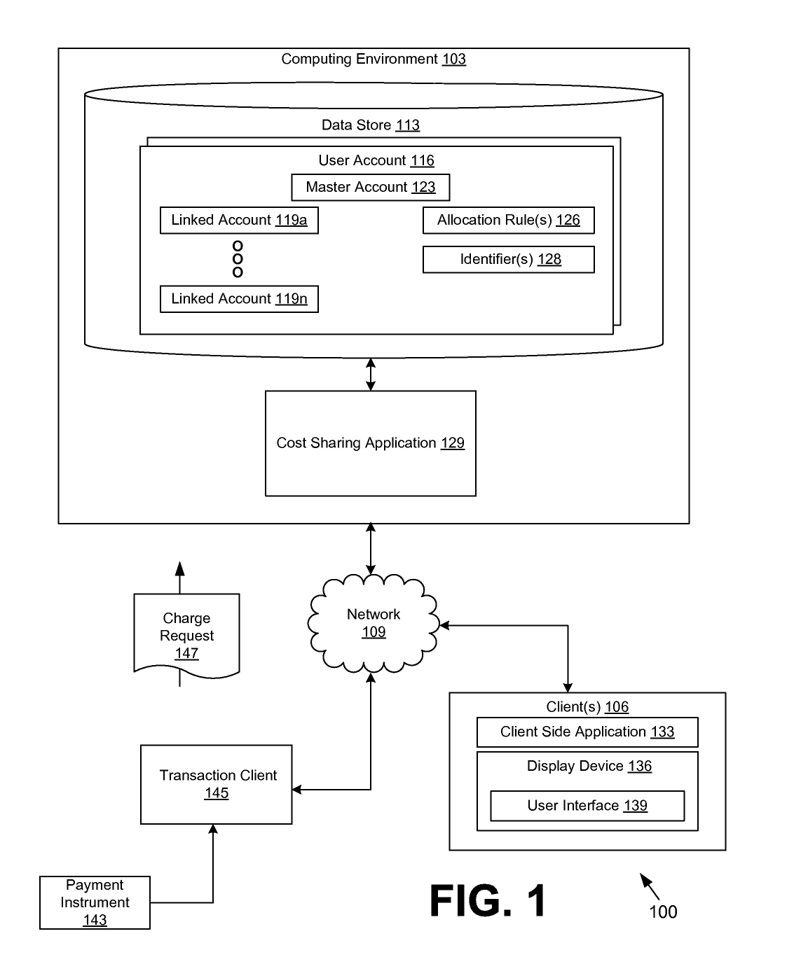

With reference to FIG. 1, shown is a networked environment 100 according to various embodiments. The networked environment 100 includes a computing environment 103 in data communication with one or more clients 106 by way of a network 109. The network 109 includes, for example, the Internet, intranets, extranets, wide area networks (WANs), local area networks (LANs), wired networks, wireless networks, or other suitable networks, etc., or any combination of two or more such networks.

The computing environment 103 may comprise, for example, a server computer or any other system providing computing capability. Alternatively, the computing environment 103 may comprise a plurality of servers or other computing devices that may be employed that are arranged, for example, in one or more server banks or computer banks or other arrangements. For example, the computing environment 103 may comprise a cloud computing resource, a grid computing resource, and/or any other distributed computing arrangement. Such computing environment 103 may be located in a single installation or may be distributed among many different geographical locations.

Various applications and/or other functionality may be executed in the computing environment 103 according to various embodiments. Also, various data is stored in a data store 113 that is accessible to the computing environment 103. The data store 113 may be representative of a plurality of data stores as can be appreciated. The data stored in the data store 113, for example, is associated with the operation of the various applications and/or functional entities described below.

The components executed on the computing environment 103, for example, include a cost sharing application 129, and other applications, services, processes, systems, engines, or functionality not discussed in detail herein. The cost sharing application 129 is executed to facilitate the creation and implementation of business rules for distributing charges to one or more accounts associated with payment instruments. The cost sharing application 129 may communicate with the client 106 over various protocols such as, for example, hypertext transfer protocol (HTTP), simple object access protocol (SOAP), user datagram protocol (UDP), transmission control protocol (TCP), and/or other protocols for communicating data over the network 109.

The data stored in the data store 113 includes, for example, user account 116, a plurality of linked accounts 119a . . . 119n, a master account 123, allocation rules 126, identifiers 128, and potentially other data. The user account 116 includes data about the user of the client 106 that is authorized to create allocation rules associated with master account 123. Such user account 116 may include information such as, usernames, passwords, security credentials, authorized applications, addresses, and/or other data. The linked accounts 119 are associated with a single master account 123. The linked accounts 119 are the respective accounts which may be charged, debited, or credited when a purchase, a cash advance, and/or other transaction is made by an authorized user of the master account 123. For example, linked accounts 119 may comprise a credit card account, a debit card account, a gift card account, a checking account, a stored value account, and/or other account.

Allocation rules 126 may be created by a user of the master account 123. The allocation rules 126 are accessed by the cost sharing application 129 to select a charge distribution allocation to use to charge one or more of the linked accounts 119 for transactions made by an authorized user of the master account 123. Each of the allocation rules 126 points to a respective charge distribution allocation. For example, a user employing a client 106 may create allocation rules 126 that select charge distribution allocations based on a specific location of a transaction, a specific store or group of stores associated with the transaction, or based on other information associated with the transaction.

Identifiers 128 serve as a mechanism to authenticate a user to gain access to information or prevent/enable transactions associated with the master account 123. For example, when an authorized user of the master account 123 wishes to access information relating to the master account 123, the user may enter identifiers 128 such as a password, a personal identification (PIN) code, an account code, name, number, and/or other form of identifying information associated with the master account 123.

The client 106 is representative of a plurality of client devices that may be coupled to the network 109. The client 106 may comprise, for example, a processor-based system such as a computer system. Such a computer system may be embodied in the form of a desktop computer, a laptop computer, a personal digital assistant, a cellular telephone, web pads, tablet computer systems, or other devices with like capability.

The client 106 may include a display device 136 and may also include one or more input devices. Such input devices may comprise, for example, devices such as keyboards, mice, joysticks, accelerometers, light guns, game controllers, touch pads, touch sticks, push buttons, optical sensors, microphones, webcams, and/or any other devices that can provide user input.

The client 106 may be employed to execute a client side application 133, and/or other applications. The client side application 133 may be executed in a client 106, for example, to access and render network pages, such as web pages, or other network content served up by the computing environment 103 and/or other servers. In this respect, the client side application 133 may comprise a browser or other applications. In one embodiment, the client side application 133 may comprise a plug-in within a browser application.

The client 106 may be configured to execute applications beyond client side application 133 such as, for example, email applications, instant message applications, and/or other applications. When executed, the client application 133 renders one or more user interfaces 139 that on the display device 136 of the client 106 in order to enable a user that manipulates such client 106 to interact with cost sharing application 129 as will be described.

Payment instrument 143 may comprise a credit card, a debit card, a gift card, a radio frequency identification (RFID) device, and/or other instrument used for making transactions. The payment instrument 143 is associated with the master account 123. For example, the payment instrument 143 may be used to access different linked accounts 119 associated with different financial institutions. Alternatively, the payment instrument 143 may be used to access multiple linked accounts 119 associated with the same financial institution. The transaction client 145 is used to scan/read payment instrument 143 and generate a charge request 147. The transaction client 145 may comprise, for example, a register, a credit card scanner, a credit card reader, an RFID checkout system, an electronic commerce system, a point-of-sale system, and/or any other system used in processing transactions involving goods and services. A charge request 147 may include for example, an identification of items purchased, refunds, cash advances, and/or other information relating to transactions made by a user of payment instrument 143.

Next, a general description of the operation of the various components of the networked environment 100 is provided. To begin, a user employs a payment instrument 143 at a transaction client 145. The transaction client 145 scans the payment instrument 143 and generates a charge request 147 in association with a given transaction such as a purchase, a refund, a cash advance, and/or other transactions made by a user of payment instrument 143. Upon receipt of the charge request 147, the transaction client 145 transmits the charge request 147 to the cost sharing application 129. The cost sharing application 129 identifies the master account 123 in the charge request 147. The cost sharing application 129 then accesses the allocation rules 126 associated with the master account 123 in order to determine a charge distribution allocation for one or more of the linked accounts 119 to charge for the charge request 147.

As an example, a user employing a client 106 manipulates the client side application 133 to enter the allocation rules 126 in the data store 113. Each of the allocation rules 126 created by the user points to a respective one of the charge distribution allocations. In one embodiment, a user may designate one or more specific transaction categories to be included in allocation rules 126 such as, entertainment, dining, shopping, utilities, etc. Upon receipt of the charge request 147 from the transaction client 145, the cost sharing application 129 identifies the master account 123 listed in the charge request 147. Once the master account 123 has been identified by the cost sharing application 129, the cost sharing application 129 accesses the allocation rules 126 in order to determine which rule applies to the information in the charge request 147. A user may also specify an application rule 126 that functions as the default rule. Once the rule that applies is identified, the cost sharing application 129 charges or credits a percentage of the amount specified in the charge request 147 to one or more of the linked accounts 119 according to the charge distribution allocation associated with the respective linked account 119. For example, the charge distribution allocation for a given linked account 119 may range from 0% to 100% of the amount specified in the charge request 147 based on the allocation rules 126. The total aggregate amount that is charged to the linked accounts 119 for each transaction does not exceed the amount specified in the charge request 147.

In one embodiment, a user employing a client 106 may specify a rule that depends on a type of merchant specified in the charge request 147 as part of the allocation rules 126 to be used by the cost sharing application 129 in determining the charge distribution allocation of the linked accounts 119 to charge for the charge request 147. For example, a user employing a client 106 may specify types of merchants such as retail, computer, hardware, plumbing, etc., to be included in the allocation rules 126. The amount charged for each transaction involving a respective type of merchant may be distributed to one or more of the linked accounts 119 based on the applicable allocation rules 126.

In another embodiment, a user employing a client 106 may create allocation rules 126 that specify the charge distribution allocation based on the location of origin of the transaction specified in the charge request 147. For example, a user employing a client 106 may create allocation rules 126 that select charge distribution allocations based on a specific location of a transaction, a specific store or group of stores associated with the transaction, or based on other information associated with the transaction.

In yet another embodiment, a user employing a client 106 may create allocation rules 126 that specify a charge distribution allocation based at least in part on the personal preferences of the user employing a client 106. For example, the user of the payment instrument 143 may specify a random charge distribution allocation in the allocation rules 126. A user may also create allocation rules 126 that specify that the linked accounts 119 that offer the greatest reward points or other benefit receive the highest charge distribution allocation. In still another embodiment, a user may create allocation rules 126 that specify that the total amount included in a charge request 147 is charged or debited to a respective one of the linked accounts 119.

In still another embodiment, a user may create allocation rules 126 that specify that the charged distribution allocation associated with each of the linked accounts 119 to be determined according to the each of corresponding available credit limits associated with each of the linked accounts 119. For example, a user employing a client 106 may create allocation rules 126 that specify that the charge distribution allocation is proportional to the available credit limit associated with each of the linked accounts 119. Accordingly, the cost sharing application 129 may track each of the available credit limits associated with each of the linked accounts 119. Additionally, the cost sharing application 129 may send an alert to a client 106 when one or more of the linked accounts 119 have reached the corresponding available credit limit. In one embodiment, the cost sharing application 129 determines whether charge distribution allocation amount exceeds the respective credit limit associated with the corresponding linked account 119. Consequently, the cost sharing application 129 may deny the charge request 147 when the charge distribution allocation amount exceeds the respective credit limit associated with the corresponding linked account 119. Alternatively, the cost sharing application 129 may access an applicable allocation rule 126 that functions as the default rule and process the charge request 147 accordingly.

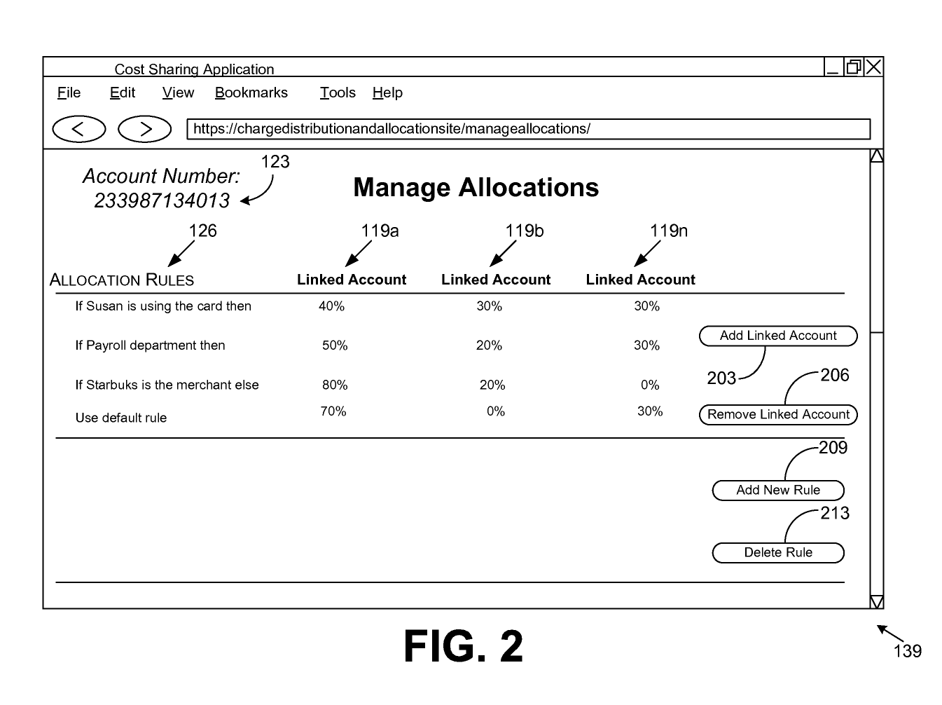

Referring next to FIG. 2, shown is one example of a user interface 139 according to various embodiments. The user interface 139 is rendered, for example, on a display 136 (FIG. 1) associated with a respective client 106 (FIG. 1) implemented by a client side application 133 (FIG. 1). In one embodiment, the user interface 139 depicts the allocation rules 126 (FIG. 1) that include the charge distribution allocation associated with each of the linked accounts 119 (FIG. 1). In one embodiment, in order to manipulate the components of the user interface 139, a user may “click” one of the components depicted in the user interface 139 by positioning a cursor over a given component and manipulating a button on a mouse associated with a client 106. Alternatively, other approaches may be used to manipulate the various buttons, icons, or other components of the user interface 139 as can be appreciated.

For example, a user may interact with the cost sharing application 129 to add, store, and/or display one or more of the linked accounts 119. A user may add a linked account 119 by “clicking” on the “add linked account” button 203 whereupon the user interface 139 is presented. Alternatively, other approaches may be employed to add linked accounts 119. Such approaches may involve the selection of boxes and buttons to cause a linked account 119 to be added. As another example, a user may delete a selected one of the linked accounts 119 by selecting a linked account 119 to be removed and “clicking” the “remove linked account” button 206. Linked accounts 119 may also be deleted in some other manner.

Similarly, a user may interact with the cost sharing application 129 to create, store, and/or display one or more of the allocation rules 126 associated with the master account 123. A user may add an allocation rule 126 by “clicking” on the “add new rule” button 209 whereupon the user interface 139 is presented. Alternatively, other approaches may be employed to create allocation rules 126. Such approaches may involve the selection of boxes and buttons to cause an allocation rule 126 to be created. Also, text boxes may be filled in with various parameters to define a rule. Additionally, a user may delete a selected one of the allocation rules 126 by selecting the allocation rule 126 to be removed and “clicking” the “delete rule” button 213. The allocation rules 126 may also be deleted in some other manner.

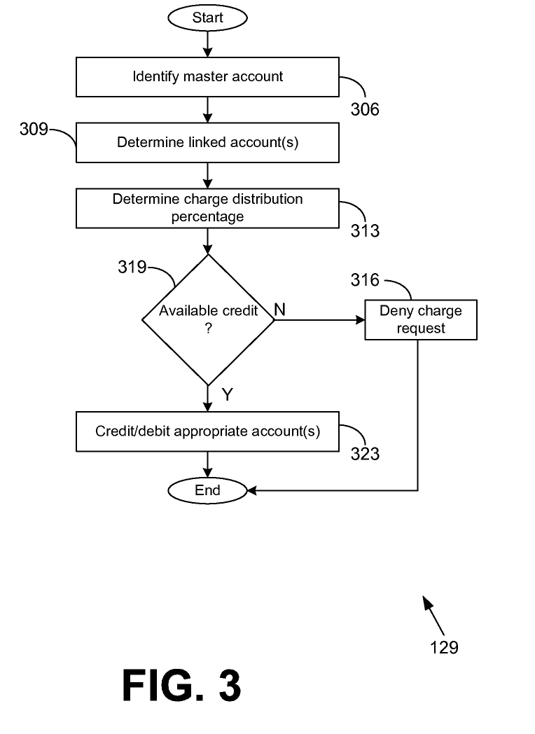

Referring next to FIG. 3, shown is a flowchart that provides one example of the operation of a portion of the cost sharing application 129 that is implemented to facilitate the creation of business rules for distributing charges to one or more linked accounts 119 (FIG. 1) associated with a payment instrument 143 (FIG. 1) according to various embodiments. It is understood that the flowchart of FIG. 3 provides merely an example of the many different types of functional arrangements that may be employed to implement the operation of the portion of the cost sharing application 129 as described herein. As an alternative, the flowchart of FIG. 3 may be viewed as depicting an example of steps of a method implemented in the computing environment 103 (FIG. 1) according to one or more embodiments.

Beginning with box 306, when a user desires to use a payment instrument 143 (FIG. 1) for purchases and other transactions at a transaction client 145 (FIG. 1), the transaction client 145 scans the payment instrument 143 and sends at charge request 147 (FIG. 1) to the cost sharing application 129. Upon receipt, the cost sharing application 129 identifies the master account 123 (FIG. 1) listed in the charge request 147 received from a transaction client 145. In box 309, the cost sharing application 129 determines one or more linked accounts 119 associated with the master account 123. The cost sharing application 129 then proceeds to box 313.

In box 313, the cost sharing application 129 accesses the allocation rules 126 (FIG. 1) associated with the master account 123 to determine which rule applies to the information in the charge request 147. In one embodiment, a user employing a client 106 may specify a rule that turns on a type of merchant specified in the charge request 147 as part of the allocation rules 126 to be used by the cost sharing application 129 in determining the charge distribution allocation of the linked accounts 119 to charge for the charge request 147. For example, a user employing a client 106 may specify types of merchants such as retail, computer, hardware, plumbing, etc. to be included in the allocation rules 126. The amount charged for each transaction involving a respective type of merchant may be distributed to one or more of the linked accounts 119 based on the applicable allocation rules 126.

In another embodiment, a user employing a client 106 may create allocation rules 126 that specify the charge distribution allocation based on the location of origin of the transaction specified in the charge request 147. For example, a user employing a client 106 may create allocation rules 126 that select charge distribution allocations based on a specific location of a transaction, a specific store or group of stores associated with the transaction, or based on other information associated with the transaction.

In yet another embodiment, a user employing a client 106 may create allocation rules 126 that specify a charge distribution allocation based at least in part on the personal preferences of the user employing a client 106. In one embodiment, each of the allocation rules 126 are considered according to a predefined priority, where the first rule in the hierarchy of rules that applies to the charge request 147 is used to process the charge request 147. Once the rule that applies is identified, the cost sharing application 129 proceeds to box 319 and determines the available credit amount associated with each of the linked accounts 119. Assuming that each of the linked accounts 119 has an amount of available credit to charge for the corresponding charge distribution allocation, the cost sharing application 129 proceeds to box 323 and charges or credits a percentage of the amount specified in the charge request 147 to one or more of the linked accounts 119 according to the charge distribution allocation associated with the respective linked account 119. Otherwise, the cost sharing application 129 proceeds to box 316 and denies the charge request 147. Thereafter, the cost sharing application ends.

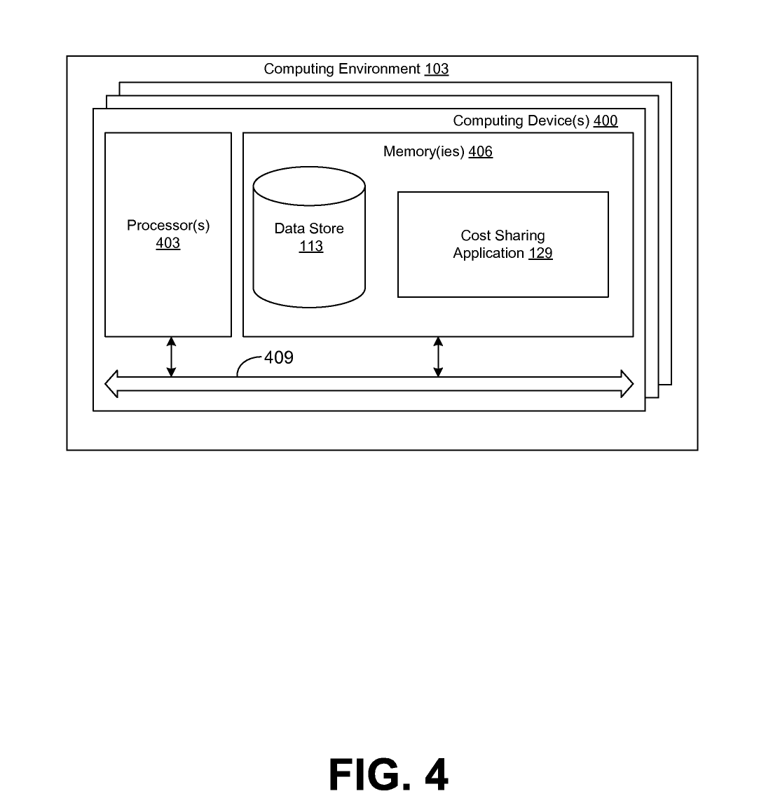

With reference to FIG. 4, shown is a schematic block diagram of the computing environment 103 according to an embodiment of the present disclosure. The computing environment 103 includes a computing device 400, at least one processor circuit, for example, having a processor 403 and a memory 406, both of which are coupled to a local interface 409. To this end, the computing device 400 may comprise, for example, at least one server computer or like device. The local interface 409 may comprise, for example, a data bus with an accompanying address/control bus or other bus structure as can be appreciated.

Stored in the memory 406 are both data and several components that are executable by the processor 403. In particular, stored in the memory 406 and executable by the processor 403 are the cost sharing application 129, and potentially other applications. Also stored in the memory 406 may be a data store 113 and other data. In addition, an operating system may be stored in the memory 406 and executable by the processor 403.

It is understood that there may be other applications that are stored in the memory 406 and are executable by the processors 403 as can be appreciated. Where any component discussed herein is implemented in the form of software, any one of a number of programming languages may be employed such as, for example, C, C++, C#, Objective C, Java, Javascript, Perl, PHP, Visual Basic, Python, Ruby, Delphi, Flash, or other programming languages.

A number of software components are stored in the memory 406 and are executable by the processor 403. In this respect, the term “executable” means a program file that is in a form that can ultimately be run by the processor 403. Examples of executable programs may be, for example, a compiled program that can be translated into machine code in a format that can be loaded into a random access portion of the memory 406 and run by the processor 403, source code that may be expressed in proper format such as object code that is capable of being loaded into a random access portion of the memory 406 and executed by the processor 403, or source code that may be interpreted by another executable program to generate instructions in a random access portion of the memory 406 to be executed by the processor 403, etc. An executable program may be stored in any portion or component of the memory 406 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 406 is defined herein as including both volatile and nonvolatile memory and data storage components. Volatile components are those that do not retain data values upon loss of power. Nonvolatile components are those that retain data upon a loss of power. Thus, the memory 406 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 403may represent multiple processors 403 and the memory 406 may represent multiple memories 406 that operate in parallel processing circuits, respectively. In such a case, the local interface 409 may be an appropriate network 109 (FIG. 1) that facilitates communication between any two of the multiple processors 403, between any processor 403 and any of the memories 406, or between any two of the memories 406, etc. The local interface 409 may comprise additional systems designed to coordinate this communication, including, for example, performing load balancing. The processor 403may be of electrical or of some other available construction.

Although cost sharing application 129, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowchart of FIG. 3 shows the functionality and operation of an implementation of portions of the cost sharing application 129. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 403in a computer system or other system. The machine code may be converted from the source code, etc. If embodied in hardware, each block may represent a circuit or a number of interconnected circuits to implement the specified logical function(s).

Although the flowchart of FIG. 3 shows a specific order of execution, it is understood that the order of execution may differ from that which is depicted. For example, the order of execution of two or more blocks may be scrambled relative to the order shown. Also, two or more blocks shown in succession in FIG. 3 may be executed concurrently or with partial concurrence. Further, in some embodiments, one or more of the blocks shown in FIG. 3 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the cost sharing application 129, that comprises software or code can be embodied in any non-transitory computer-readable medium for use by or in connection with an instruction execution system such as, for example, a processor 403in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A non-transitory computer-readable medium embodying a program executable in a computing device, the program comprising:
code that determines a master account listed in a charge request received from a transaction client, wherein the master account is associated with a plurality of payment instruments, wherein the plurality of payment instruments are associated with a plurality of individuals, and wherein the master account is shared among the individuals;
code that determines a charge distribution allocation associated with a plurality of linked accounts based on an allocation rule, the linked accounts being associated with the master account;
code that determines an available credit amount associated with the linked accounts;
code that causes at least a portion of the amount specified in the charge request to be charged to a plurality of the linked accounts; and
wherein the allocation rule determines the charge distribution allocation based at least in part on a one of the linked accounts having a greatest amount of offered reward points with respect to others of the linked accounts.

2. The non-transitory computer-readable medium of claim 1, wherein at least one of the allocation rules is manually specified by a user.

3. The non-transitory computer-readable medium of claim 1, further comprising code that denies the charge request when the amount specified in the charge request exceeds the available credit limit associated with a respective one of the linked accounts.

4. A system, comprising:
at least one computing device; and
a master account stored in a data store accessible to at least one computing device, wherein the master account is associated with a plurality of payment instruments and the plurality of payment instruments are associated with a plurality of individuals;
a plurality of linked accounts stored in the data store in association with the master account;
a plurality of allocation rules stored in the data store, wherein individual allocation rules comprises a charge distribution allocation that indicates a charge distribution across the linked accounts;
a cost sharing application executable in the at least one computing device, the cost sharing application comprising:
logic that, in response to receiving a charge request from a transaction client, looks up the master account included in the charge request;
logic that determines the charge distribution allocation based on a respective one of the allocation rules associated with the master account;
logic that causes up to a total amount indicated in the charge request to be charged to the plurality of linked accounts; and
wherein the charge distribution allocation is based at least in part on reward points offered by at least one of the linked accounts.

5. The system of claim 4, wherein the charge distribution allocation dictates the total amount charged to each of the linked accounts.

6. The system of claim 4, wherein the cost sharing application further comprises logic that determines a type of transaction associated with the charge request.

7. The system of claim 6, wherein the at least one of the allocation rules determines the charge distribution allocation based on the type of transaction.

8. The system of claim 4, wherein the cost sharing application further comprises logic that obtains an entity identifier from the charge request.

9. The system of claim 8, wherein the at least one of the allocation rules determines the charge distribution allocation based on the entity identifier obtained from the charge request.

10. The system of claim 4, further comprising a plurality of personal identification numbers associated with each of the payment instruments.

11. The system of claim 10, wherein the cost sharing application further comprises logic that looks up the personal identification number from the charge request.

12. The system of claim 11, wherein the at least one of the allocation rules determines the charge distribution allocation based on the personal identification number obtained from the charge request.

13. The system of claim 4, wherein the cost sharing application further comprises logic that generates at least one user interface that facilitates interaction with the cost sharing application to specify at least one of the allocation rules, the at least one user interface being configured for rendering for display on a display device of a client.

14. A method, comprising:
receiving, via at least one computing device, a charge request associated with a master account from a transaction client, wherein the master account is associated with a plurality of linked accounts;
determining, via at least one computing device, at least one allocation rules applicable to the charge request, wherein the at least one allocation rule has associated therewith a charge distribution allocation indicating a charge distribution across the plurality of linked accounts;
tracking, via at least one computing device, an available credit amount associated with individual ones of the linked accounts;
causing, in the at least one computing device, up to a total amount indicated in the charge request to be charged to at least two of the linked accounts based at least in part on an applicable one at least one allocation rule; and
wherein the applicable one of the allocation rules determines the charge distribution allocation proportional to the available credit amount associated with the linked accounts.

15. The method of claim 14, further comprising sending an alert to a client when at least one of available credit limits has been reached.

16. The method of claim 14, further comprising determining a location of origin of the charge request.

17. The method of claim 16, wherein the applicable one of the allocation rules determines the charge distribution allocation based at least in part on the location of origin.

18. The method of claim 14, further comprising determining a transaction category indicated in the charge request.

19. The method of claim 18, wherein the applicable one of the allocation rules determines the charge distribution allocation based at least in part on the transaction category.

20. The method of claim 14, further comprising determining a type of merchant indicated in the charge request.

21. The method of claim 20, wherein the applicable one of the at least one allocation rules determines the charge distribution allocation based at least in part on the type of merchant.
